(19) United States
(12) Patent Application Publication
(10) Pub. No.: US 2024/0169190 A1
(43) Pub. Date: May 23, 2024

(54) DEVICE AND METHOD WITH QUANTIZATION PARAMETER

(71) Applicants: SAMSUNG ELECTRONICS CO., LTD., Suwon-si (KR); UNIST(ULSAN NATIONAL INSTITUTE OF SCIENCE AND TECHNOLOGY), Ulsan (KR)

(72) Inventors: Hyeonuk SIM, Suwon-si (KR); Sangyun OH, Ulsan (KR); Jongeun LEE, Ulsan (KR)

(73) Assignees: SAMSUNG ELECTRONICS CO., LTD., Suwon-si (KR); UNIST(ULSAN NATIONAL INSTITUTE OF SCIENCE AND TECHNOLOGY), Ulsan (KR)

(21) Appl. No.: 18/314,512

(22) Filed: May 9, 2023

(30) Foreign Application Priority Data
Nov. 11, 2022 (KR) 10-2022-0150855

(51) Int. Cl. G06N 3/0495; G06F 5/01

(52) U.S. Cl. CPC G06N 3/0495; G06F 5/01

(57) ABSTRACT

An electronic device includes: a shifter configured to perform a shift operation based on a codebook supporting a plurality of quantization levels preset for data bits of a data set; and a decoder configured to control the shifter by setting quantization scales of the data bits differently for preset groups, wherein the shifter is configured to quantize and output the data bits by control of the decoder.

### CROSS-REFERENCE TO RELATED APPLICATIONS

This application claims the benefit under 35 USC § 119(a) of Korean Patent Application No. 10-2022-0150855, filed on Nov. 11, 2022 in the Korean Intellectual Property Office, the entire disclosure of which is incorporated herein by reference for all purposes.

### BACKGROUND

### 1. Field

The following description relates to a device and method with quantization.

### 2. Description of Related Art

A hardware deep neural network (DNN) accelerator may achieve a high performance in implementing various machine-learning tasks. Computer vision tasks, such as image enhancement and super-resolution application, often require exceptionally high computing and memory for DNN. Quantization may be a highly effective approach to reduce the hardware cost of such a DNN accelerator and the memory space of the DNN accelerator.

Quantization of a neural network may include a quantizer and a quantization algorithm using the quantizer. The quantizer may define a codebook (e.g., a set of quantization representation values using a specific scale and the number of available bits) and reduce data complexity by converting target data to an integer. In addition, the quantization algorithm may refer to an algorithm of reducing the data complexity of a neural network by optimizing the quantizer while minimizing subsequent performance degradation.

The quantizer optimization of a quantization algorithm may use a quantization parameter for scaling a target, such as a codebook and input data, necessary for a quantization process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes: a shifter configured to perform a shift operation based on a codebook supporting a plurality of quantization levels preset for data bits of a data set; and a decoder configured to control the shifter by setting quantization scales of the data bits differently for preset groups, wherein the shifter is configured to quantize and output the data bits by control of the decoder.

The quantization scales may be determined based on a scale parameter for minimizing a quantization error when quantizing the data set with an approximate weight in a preset operation.

The data set may correspond to a subset selected from some pieces of data, of which a similarity is high with a subset generated based on a Lloyd-Max quantization technique, of a randomly generated universal set.

The preset groups may include either one or both of a channel and a layer of a neural network.

The scale parameter may be derived through an iterative operation based on a following equation:

$$∀ i , α {q}_{i} = {arg min}_{p ∈ {S}_{Q}} \vert p - {w}_{i} \vert \\ ℒ = {\sum }_{i} {( {w}_{i} - α {q}_{i} )}^{2} \\ {α}^{*} = \frac{{Σ}_{i} {w}_{i} \cdot {q}_{i}}{{Σ}_{i} {q}_{i}^{2}} ,$$

and α may denote the scale parameter, wᵢ may denote an element of a subset, qⱼ may denote a quantization point of the subset, L may denote the quantization error, and S_{Q} may equal {αqⱼ}.

The data bits may be quantized at a log level of 2.

In one or more general aspects, a processor-implemented method includes: selecting some pieces of data from a quantized universal set in a preset operation; performing quantization with an approximate weight on the selected pieces of data; determining a quantization error for the quantized pieces of data; and deriving a scale parameter value for minimizing the determined quantization error.

The selecting the pieces of data in the preset operation may include selecting the pieces of data, of which a similarity is high with a subset generated based on a Lloyd-Max quantization technique, from the universal set.

The deriving the scale parameter value for minimizing the determined quantization error may include: determining an initial value of the scale parameter; updating the scale parameter based on a change of the quantization error; and outputting the scale parameter when the change of the quantization error is less than or equal to a preset reference value.

The deriving the scale parameter value for minimizing the determined quantization error may include deriving the scale parameter value for minimizing the quantization error through an iterative operation based on a following equation:

$$∀ i , α {q}_{i} = {arg min}_{p ∈ {S}_{Q}} \vert p - {w}_{i} \vert \\ ℒ = {\sum }_{i} {( {w}_{i} - α {q}_{i} )}^{2} \\ {α}^{*} = \frac{{Σ}_{i} {w}_{i} \cdot {q}_{i}}{{Σ}_{i} {q}_{i}^{2}} ,$$

and α may denote the scale parameter, wᵢ may denote an element of a subset, qⱼ may denote a quantization point of the subset, L may denote the quantization error, and S_{Q} may equal {αqⱼ}.

The scale parameter may be set differently for each channel or each layer.

The method may include reperforming the quantization with the approximate weight on the selected pieces of data using the derived scale parameter value.

The method may include: determining a quantized approximate weight based on the reperforming of the quantization; and quantizing a neural network using the quantized approximate weight.

In one or more general aspects, a non-transitory computer-readable storage medium stores instructions that, when executed by a processor, configure the processor to perform any one, any combination, or all of operations and/or methods described herein.

In one or more general aspects, an electronic device includes: one or more processors configured to: select some pieces of data from a quantized universal set in a preset operation; perform quantization with an approximate weight on the selected pieces of data; determine a quantization error for the quantized pieces of data; and derive a scale parameter value for minimizing the determined quantization error.

For the selecting of the pieces of data in the preset operation, the one or more processors may be configured to select the pieces of data, of which a similarity is high with a subset generated based on a Lloyd-Max quantization technique, from the universal set.

For the deriving of the scale parameter value, the one or more processors may be configured to: determine an initial value of the scale parameter; update the scale parameter based on a change of the quantization error; and output the scale parameter when the change of the quantization error is less than or equal to a preset reference value.

For the deriving of the scale parameter value, the one or more processor may be configured to derive the scale parameter value for minimizing the quantization error through an iterative operation based on a following equation:

$$∀ i , α {q}_{i} = {arg min}_{p ∈ {S}_{Q}} \vert p - {w}_{i} \vert \\ ℒ = {\sum }_{i} {( {w}_{i} - α {q}_{i} )}^{2} \\ {α}^{*} = \frac{{Σ}_{i} {w}_{i} \cdot {q}_{i}}{{Σ}_{i} {q}_{i}^{2}} ,$$

and α may denote the scale parameter, wᵢ may denote an element of a subset, qⱼ may denote a quantization point of the subset, L may denote the quantization error, and S_{Q} may equal {αqⱼ}.

The scale parameter may be set differently for each channel or each layer.

The device may include a memory storing instructions that, when executed by the one or more processors, configure the one or more processors to perform the selecting of the pieces of data, the performing of the quantization, the determining of the quantization error, and the deriving of the scale parameter value.

Other features and aspects will be apparent from the following detailed description, the drawings, and the claims.

### BRIEF DESCRIPTION OF THE DRAWINGS

FIG. 1 illustrates an example of a method of deriving a scale parameter for quantization scaling.

FIG. 2 illustrates an example of a method of selecting pieces of data from a universal set.

FIG. 3 visually illustrates an example of a whole scheme of a quantization scaling method.

FIG. 4 illustrates an example of performing quantization scaling.

FIGS. 5A and 5B illustrate examples of a structure of a quantization scaling device.

FIG. 6 illustrates an example of a configuration of a device for performing a method of deriving a scale parameter.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

The same name may be used to describe an element included in the example embodiments described above and an element having a common function. Unless otherwise mentioned, the descriptions on the example embodiments may be applicable to the following example embodiments and thus, duplicated descriptions will be omitted for conciseness.

A quantization method, for example, may be based on subset quantization. To this end, a quantization point set for a range of a simulated quantization function may be defined. In an example, quantization with 4 bits is mainly described, as a non-limiting example. The quantization may be with any other number of bits (e.g., 8 bits), according to other non-limiting examples.

Subsets may be configured for a codebook-based universal set. In this case, the number of pieces of data included by a subset may be determined based on quantization precision. As described above, a 4-bit subset may be configured.

In an example, in n-bit quantization (including a sign bit), a N=2n−1 value may be selected from 0 or a positive number. In this case, 0 may be included or not included. For example, N=8 when n=4 and N=4 when n=3. Various methods may be used to select a subset.

When a subset for quantization is selected, a subset of a negative number that is symmetrical to the positive number based on 0 may be simply defined through a sign. When a quantization point is defined to be symmetrical, hardware complexity may decrease when constructing or configuring a quantization device.

A scale parameter may be defined to determine a scale of the subset generated in this example. The scale parameter may be determined based on a quantization result of a universal set and be implemented as a portion of a subsequent layer in hardware.

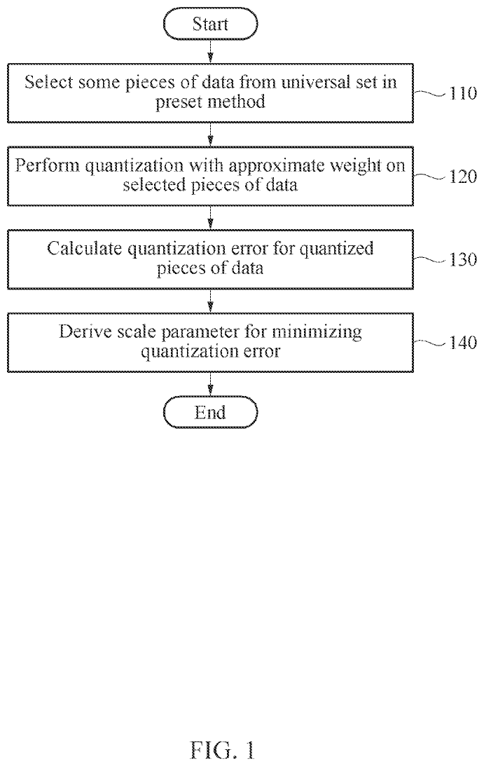

FIG. 1 illustrates an example of a method of deriving a scale parameter for quantization scaling.

In an example, a plurality of subsets may be generated for a universal set of a codebook, and of the generated subsets, an optimal subset may be derived through Lloyd-Max quantization and a codebook similarity. In addition, based on the derived optimal subset, a scale parameter for minimizing a quantization error may be obtained (e.g., determined). Accordingly, the method of one or more embodiments may be used to quantize a neural network without using a data set for training, thereby advantageously reducing hardware complexity and a number of operations for quantizing the neural network.

In operation 110, a device may select some pieces of data from a quantized universal set in a preset method (e.g., operation).

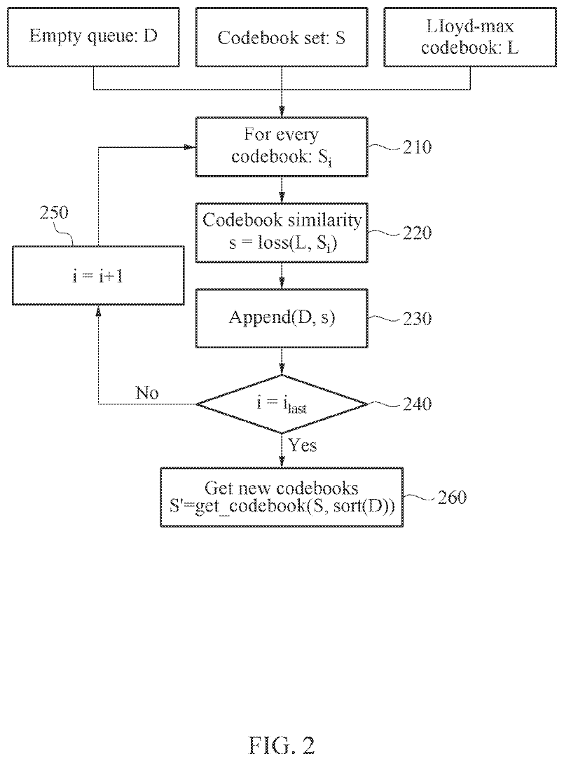

FIG. 2 illustrates an example of a method of selecting pieces of data from a universal set.

In an example, in operation 210, the universal set may be generated to search for a codebook by an approximate weight. Of the universal set, a device may generate an ideal set, that is, a codebook L, or a Lloyd-Max codebook L, including a floating point through a Lloyd-Max quantization technique.

In addition, in operation 220, a similarity between elements included by the universal set and elements included by the codebook L may be calculated (e.g., determined), and accordingly, some pieces of data may be selected.

For example, in operation 230, the calculated similarity may be stored in an empty queue, that is, a queue D. When the calculation of the similarity with respect to the universal set is completed (for example, when operations 210, 220, and 230 are iteratively performed in response to operation 250 until i=iₗₐₛₜ in operation 240), the device may sort values stored in the queue D in a ascending order in operation 260. The device may select elements of which a similarity is high with the codebook L. For example, pieces of data of which the similarity corresponds to 3% may be selected.

In operation 260, the selected pieces of data may be used to generate subsets, that is, candidates for a new codebook.

In operation 120, the device may perform quantization with an approximate weight on the selected pieces of data.

In an example, a plurality of subsets may be generated for the selected pieces of data. Quantization may be performed on an approximate weight w for all the pieces of data selected in a process of generating the subsets, and a quantized approximate weight may be obtained.

In operation 130, the device may calculate a quantization error for the quantized pieces of data.

In an example, a difference between the approximate weight w included by a subset and a quantized approximate weight wq may be calculated.

In operation 140, the device may derive a scale parameter value for minimizing the calculated quantization error.

In an example, based on the calculated result, a scale parameter value for reducing a quantization error may be calculated. A scale parameter may be iteratively accumulated and calculated. For example, based on a primarily calculated scale parameter, quantization on a subset may be performed again, the quantization error may be calculated again, and based on the calculated quantization error, the scale parameter may be calculated again.

This cycle may be iterated until the quantization error decreases down to a preset reference value or the quantization error no longer decreases. Accordingly, based on the calculated scale parameter, the approximate weight may be quantized to a quantization point of which the quantization error is small.

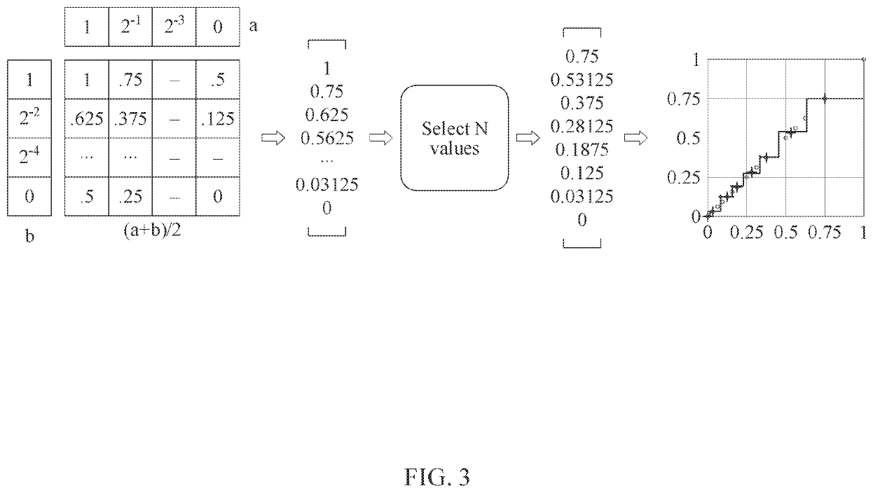

FIG. 3 visually illustrates an example of a whole scheme of a quantization scaling method.

As described above, the example relates to 4-bit quantization including a sign bit, in which N=8.

In an example, a codebook-based universal set may be generated, and a subset representing a quantization point by using N pieces of data among pieces of data selected through a Lloyd-Max-based method from the codebook-based universal set.

In an example, a subset corresponding to a simulated quantization range may be defined. A quantization apparatus used for simulation may include and sequentially use a quantization device and an inverse-quantization device, and an input thereto and an output therefrom may have the same scale. Accordingly, the subset may be a point set of an input domain in which quantization may be performed without a quantization error. The input may be approximated to elements close to the subset through simulation. Unlike a typical quantization system, a quantization system of one or more embodiments may be configured by using a general quantization device in a method of using a scale parameter for minimizing a quantization loss other than the input.

$$Q ( x , {S}_{Q} ) = {arg min}_{p ∈ {S}_{Q}} \vert x - p \vert . \qquad Equation 1$$

Equation 1 may correspond to a quantization result of a subset by a simulated quantization device. Here, x denotes an input, S_{Q} denotes a subset of which a quantization loss is minimized, and p denotes a quantization point included by the subset.

For example, a subset for linear quantization may be defined by Equation 2 below, for example.

S_{Q}^{lin}(α)={α·i|i=−N,−N+1, . . . ,N−1} Equation 2:

Here, α denotes a scale parameter and 2N denotes the number of quantization points. In other words, k-bit quantization may be represented by N=2k−1, and a symmetrical form based on 0 may be applied thereto.

A subset for log-scale quantization may be defined by Equation 3 below, for example.

S_{Q}^{log}(α)={−α2⁻ⁱ|i=0,1, . . . ,N−1}∪{0}∪{α2⁻ⁱ|i=0,1, . . . ,N−2} Equation 3:

As a method of improving the accuracy of the log-scale quantization, a subset for a quantization point of 2 that is defined by Equation 4 below, for example, may be used.

S_{Q}^{2 log}(α)={q₁+q₂|q₁∈S_{Q}^{log}(α),q₂∈S_{Q}^{log}(α)} Equation 4:

Here, q₁ and q₂ denotes quantization points corresponding to a scale parameter.

The concept of quantizing the subset may refer to defining a subset corresponding to a codebook in a preset size of a universal set based on a whole codebook that is a greater set.

S_{Q}^{sq}(α)={any qᵢ∈S_{U}(α)|i=1, . . . ,2N} Equation 5:

Equation 5 may be a subset of a whole codebook S_{U}(α) including the number, less than or equal to 2N, of elements. Quantization precision may limit the size of a quantization point set but may not limit a universal set.

In an example, the simulated quantization device may be defined according to Equation 1 and may be defined flexibly by a scale parameter. In other words, the operation of determining a scale parameter may optimize a result of quantization by a quantization device.

A quantization method may be performed with selecting different subsets for each layer and/or each channel of a neural network.

Although all real number values may be used as a universal set, a universal set S_{Q}^{2 log}; similar to a quantization point set corresponding to a 2-log scale quantization method of which hardware complexity is low and efficiency is high may be used.

Hereinafter, a process of optimizing the quantization of a subset is described.

The quantization of a subset may be optimized to minimize a quantization error of the subset. To this end, the subset may be specified, and a scale parameter value may be determined.

An optimal scale parameter may be efficiently found in a provided quantization point set.

$$∀ i , α {q}_{i} = {arg min}_{p ∈ {S}_{Q}} \vert p - {w}_{i} \vert . \\ ℒ = {\sum }_{i} {( {w}_{i} - α {q}_{i} )}^{2} . \qquad Equation 6$$

Equation 6 relates to a method of calculating a quantization error. Under the assumption that qⱼ denotes a quantization point set corresponding to a subset (prior to applying a scale parameter thereto), a final quantization point set, to which the scale parameter is applied, may be S_{Q}={αqⱼ}. A loss between a subset value wᵢ and a quantized value may be calculated, and αqᵢ may be assumed to be a quantization point that is the closest to the subset value wᵢ.

$${α}^{*} = \frac{{Σ}_{i} {w}_{i} \cdot {q}_{i}}{{Σ}_{i} {q}_{i}^{2}} \qquad Equation 7$$

As described above, to find a scale parameter for minimizing the quantization error L, a derivative of the quantization error L of α may be set to 0.

In Equation 6, finding αqᵢ may depend on a current value of α. Therefore, the operations of Equations 6 and 7 may be iterated until α converges to a certain value. In this case, α may be set to have 1 as an initial value.

As an experimental result, when a tolerance of α is 1e-5, the optimization method may obtain a convergence value within an average of 17 iterations.

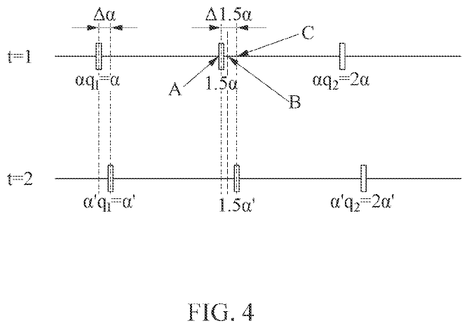

FIG. 4 illustrates an example of performing quantization scaling.

Hereinafter, an example of finding an optimal scale parameter for a provided quantization point set S(α)={αqⱼ} for minimizing a quantization error L2 is described.

First, α may be initialized to 1, and then, α may be updated by using Equation 7 until α no longer changes. qᵢ on the right of Equation 7 is a short form of q(wᵢ, α) as shown in Equation 8 below, for example.

$${q}_{i} := q ( {w}_{i} , α ) = \frac{1}{α} \cdot {arg min}_{p ∈ S ( α )} \vert p - {w}_{i} \vert \qquad Equation 8$$

When α is updated according to Equation 7, qᵢ=q(wᵢ, α) may be updated or may not be updated. When qᵢ is not updated (that is, if ∀ᵢ, q(wᵢ, α)=q(wᵢ, α*)), a quantization error may be a simple quadratic on α, an optimal value of α may be determined through Equation 7, and iterations may be terminated.

Referring to FIG. 4, when α increases by Δα=α′−α, a closest quantization point may change. In an example, q₁=1 and q₂=2.

When some qᵢ is updated (that is, ∃ᵢ and q(wᵢ, α)∉q(wᵢ, α*)), an L value may temporarily decrease or remain the same or temporarily increase and decrease thereafter. An example is provided with reference to FIG. 4 to verify the descriptions above.

In an example, in a first iteration t=1 using S(α)={αq₁, αq₂}, only a weight value w that is quantized to a quantization point set may be used. In the first iteration t=1, α may be updated to α′ under the assumption of α′>α.

Then, in a second iteration t=2, the weight value w may be quantized through S(α′)={α′q₁, α′q₂}. For further simplification, quantization points q1 and q2 may be assumed to be q1=1 and q2=2. Referring to FIG. 4, A=1.5α, C=1.5α′, and B=A+0.5Δα, in which Δα=α′. There may be three examples based on the points of A, B, and C.

Example 1: All the points between α′ and 1.5α(=A) may be quantized to αq₁ (in the first iteration t=1) or α′q₁ (in the second iteration t=2). In this case, q(w, α) may not be updated.

Example 2: Similarly, all the points between 1.5α′ (=C) and 2α may be quantized to αq2 (in the first iteration t=1) or α′q2 (in the second iteration t=2). In this case, q(w, α) may not be updated.

Example 3: When the weight value w is between A and C, q(w, α) may be updated from q2 to q1. There may be two examples.

First, when the weight value w is greater than B, a quantization error in the second iteration t=2 may decrease compared to a quantization error in the first iteration t=1. Conversely, when the weight value w is less than B, the quantization error in the second iteration t=2 may increase compared to the quantization error in the first iteration t=1. In this case, a quantization error may not monotonously decrease according to Equation 7. To prevent the quantization error from oscillating and converging, α may decrease through Equation 7, and then, the next cycle may need to be a t=1 situation, which may not be possible. When the weight value w is less than B, the quantization error may be w−α′, which may be minimized when α increases. There may be no infinite oscillation between two a values, and the quantization error may temporarily increase but eventually converge to a minimum value.

Although the example relates to α′>α, convergence when α′<α may be similarly represented.

An algorithm according to the example may be represented as below.

TABLE 1
Algorithm 1: FINDBESTQPS

| | Input: w: pretrained weight, S_{U}: universal set, N: 2^{k-1}, |
|---|---|
| | loss(w, S): loss function |
| | Result: S_{Q}: the QPS that minimizes loss |
| 1 | lₘᵢₙ ← ∞ |
| 2 | for S in each N-element subset of S_{U} do |
| 3 | \| α ← FINDSCALEFACTOR(S, w) |
| 4 | \| l_{curr} ← loss(w, αS) |
| 5 | \| if l_{curr} < lₘᵢₙ then |
| 6 | \| \| S_{Q} ← αS |
| 7 | \| \| lₘᵢₙ ← l_{curr} |
| 8 | \| end |
| 9 | end |
| 10 | return S_{Q} |

The number of subsets to be considered to find an optimal subset may be

$$\begin{matrix}\vert {S}_{U} \vert \\ \vert {S}_{Q} \vert\end{matrix} .$$

Accordingly, all the cases providing a minimum quantization error may be considered. In an example, a scale parameter may be derived for each layer or each channel.

Hereinafter, a method of generating a universal set is described.

An initial candidate of a universal set S_{U} may be represented by S_{Q}^{2 log}, in which two shifters and one adder may be implemented in hardware. In an example, a configuration to optimize such hardware may be used.

In an example, a form of +b may be used. In this case, a and b may be represented by 0 or 2k as shown in Table 2. Because a subset is the same as a scaled version by a scale parameter, the subset may be scaled as below, and a value thereof may be less than or equal to 1.

TABLE 2

| Option | A | B |
|---|---|---|
| 1 | {2⁻¹, 2⁻², 2⁻³, 0} | {2⁻¹, 2⁻², 2⁻⁴, 0} |
| 2 | {1, 2⁻², 2⁻⁴, 0} | {2⁻¹, 2⁻³, 2⁻⁵, 0} |
| 3 | {1, 2⁻¹, 2⁻², 2⁻³, 2⁻⁴, 0} | {1, 2⁻¹, 2⁻², 2⁻³, 2⁻⁴, 0} |
| 4 | {1, 2⁻¹, 2⁻², 2⁻³, 2⁻⁴, 2⁻⁵, 0} | {1, 2⁻¹, 2⁻², 2⁻³, 2⁻⁴, 2⁻⁵, 0} |
| 5 (chosen) | {1, 2⁻¹, 2⁻³, 0} | (1, 2⁻², 2⁻⁴, 0} |

The configuration of a universal set according to an example may be balanced between the representation and complexity of hardware. For example, option 4 may generate a universal set including 23 elements while options 3 and 5 include 17 and 16 elements, and option 4 may be the most complex. In an example, option 5 may be selected and implemented in simple hardware.

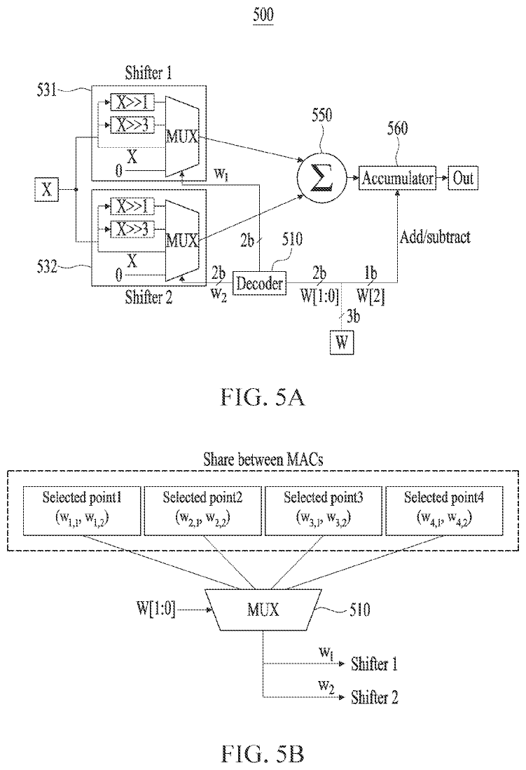

Hardware for quantization scaling may be represented as illustrated in FIGS. 5A and 5B.

FIGS. 5A and 5B illustrate examples of a quantization device for quantization scaling and hardware configuration through a multiply-and-accumulate (MAC) operation.

FIG. 5A illustrates a structure of a MAC-based quantization device 500 and FIG. 5B illustrates a structure of a decoder 510 of the MAC-based quantization device 500.

The implementation thereof may be assumed to be linearly quantized, and a weight may be assumed to be quantized to a subset. In a simple method of implementing a universal set, two shifters (e.g., shifter 1 531 and shifter 2 532) and one adder 550 may be used. In this case, the shifters 531 and 532 may be a variable shifter, that is, a barrel shifter.

By using the definition of all universal sets, the quantization device 500 may be optimized as a simple configuration as illustrated in FIGS. 5A and 5B. Referring to FIG. 5A, each of the shifters 531 and 532 (shifters 1 and 2) may be two shifters shifting a certain amount and a multiplexer (MUX). The shifters 531 and 532 may perform a shift operation based on a codebook supporting a plurality of quantization levels preset for data bits corresponding to a quantization target.

A MUX used in a configuration may be economical compared to a barrel shifter. For example, a logic gate may not be used to shift a certain amount of constant, and the configuration may be implemented through a simple wire. A hardware configuration may be configured based on a method of generating a universal set. In this case, four results, including 0, may be output for each term.

Because each MUX may independently select an input, there may be 16 different combinations, among which the width of a quantized weight value being limited and used in practice may be in 4 combinations. Accordingly, a quantization point set may select the 4 combinations to be used in practice and use the 4 combinations to implement the decoder 510.

The decoder 510 in FIG. 5B may include a 16-bit register (4×4 bits) and a 4-bit 4-to-1 MUX. The 16-bit register may store a quantization point set (that is, a 2-bit log value) selected by the algorithm in Table 1 and share the quantization point set among all MACs of the same layer or the same channel according to quantization particleness. In an example, the decoder 510 may control an output of a shifter included by a MAC such that the decoder 510 may apply a quantization scale of data bits to the same group, such as the same channel or the same layer. Accordingly, the quantization scale of data bits may set differently for each group.

Thereafter, the decoder 510 may be reduced to a simple MUX, and the simple MUX may be shared among MACs in a MAC array according to a data flow of the MAC array. In summary, the hardware cost of an optimized MAC may be very small. The optimized MAC may be implemented by two 4-to-1 MUXs, one adder 550, one accumulator 560, and one 4-to-1 MUX and may be quantized by being shared among MACs according to a hardware data flow.

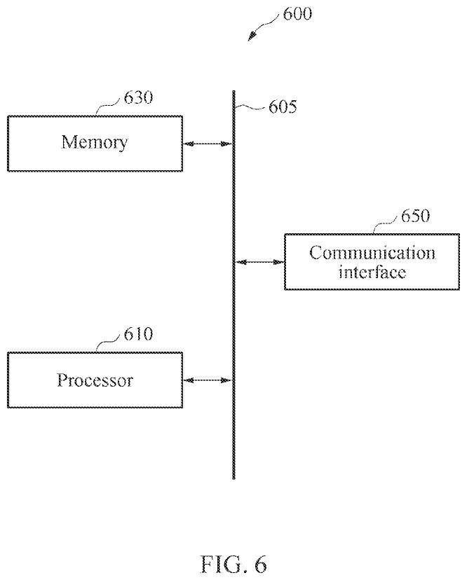

FIG. 6 illustrates an example of a configuration of a device for performing a method of deriving a scale parameter.

A device 600 may include a processor 610 (e.g., one or more processors), a memory 630 (e.g., one or more memories), and a communication interface 650. The processor 610, the memory 630, and the communication interface 650 may communicate with one another through a communication bus 605.

In an example, the processor 610 may perform a scale parameter calculation method for quantization scaling. Accordingly, the device 600 may execute through a program an operation of selecting some pieces of data of a quantized universal set in a preset method, an operation of performing quantization with an approximate weight on the selected pieces of data, an operation of calculating a quantization error for the quantized pieces of data, and an operation of deriving a scale parameter for minimizing the calculated quantization error.

The memory 630 may be a volatile memory or a non-volatile memory, and the processor 610 may execute the program and control the device 600. The code of the program executed by the processor 610 may be stored in the memory 630. For example, the memory 630 may store instructions that, when executed by the processors 610, configure the processor 610 to perform any one, any combination, or all of the operations and methods described herein with reference to FIGS. 1-6. The device 600 may be connected to an external device (e.g., a personal computer (PC) or a network) through an input/output device (not shown) to exchange data therewith. The device 600 may be mounted on various computing devices and/or systems, such as a smartphone, a tablet computer, a laptop computer, a desktop computer, a television (TV), a wearable device, a security system, a smart home system, and the like.

The computing apparatuses, electronic devices, processors, memories, storage devices, quantization devices, decoders, shifters, adders, devices, communication interfaces, communication buses, quantization device 500, decoder 510, shifters 531 and 532, adder 550, device 600, processor 610, memory 630, communication interface 650, communication bus 605, and other apparatuses, devices, units, modules, and components disclosed and described herein with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, the device comprising:
a shifter configured to perform a shift operation based on a codebook supporting a plurality of quantization levels preset for data bits of a data set; and
a decoder configured to control the shifter by setting quantization scales of the data bits differently for preset groups,
wherein the shifter is configured to quantize and output the data bits by control of the decoder.

2. The device of claim 1, wherein the quantization scales are determined based on a scale parameter for minimizing a quantization error when quantizing the data set with an approximate weight in a preset operation.

3. The device of claim 2, wherein the data set corresponds to a subset selected from some pieces of data, of which a similarity is high with a subset generated based on a Lloyd-Max quantization technique, of a randomly generated universal set.

4. The device of claim 1, wherein the preset groups comprise either one or both of a channel and a layer of a neural network.

5. The device of claim 1, wherein
the scale parameter is derived through an iterative operation based on a following equation:
$$∀ i , α {q}_{i} = {arg min}_{p ∈ {S}_{Q}} \vert p - {w}_{i} \vert \\ ℒ = {\sum }_{i} {( {w}_{i} - α {q}_{i} )}^{2} \\ {α}^{*} = \frac{{Σ}_{i} {w}_{i} \cdot {q}_{i}}{{Σ}_{i} {q}_{i}^{2}} ,$$
and
α denotes the scale parameter, wᵢ denotes an element of a subset, qⱼ denotes a quantization point of the subset, L denotes the quantization error, and S_{Q}={αqⱼ}.

6. The device of claim 1, wherein the data bits are quantized at a log level of 2.

7. A processor-implemented method, the method comprising:
selecting some pieces of data from a quantized universal set in a preset operation;
performing quantization with an approximate weight on the selected pieces of data;
determining a quantization error for the quantized pieces of data; and
deriving a scale parameter value for minimizing the determined quantization error.

8. The method of claim 7, wherein the selecting the pieces of data in the preset operation comprises selecting the pieces of data, of which a similarity is high with a subset generated based on a Lloyd-Max quantization technique, from the universal set.

9. The method of claim 7, wherein the deriving the scale parameter value for minimizing the determined quantization error comprises:
determining an initial value of the scale parameter;
updating the scale parameter based on a change of the quantization error; and
outputting the scale parameter when the change of the quantization error is less than or equal to a preset reference value.

10. The method of claim 7, wherein
the deriving the scale parameter value for minimizing the determined quantization error comprises deriving the scale parameter value for minimizing the quantization error through an iterative operation based on a following equation:
$$∀ i , α {q}_{i} = {arg min}_{p ∈ {S}_{Q}} \vert p - {w}_{i} \vert \\ ℒ = {\sum }_{i} {( {w}_{i} - α {q}_{i} )}^{2} \\ {α}^{*} = \frac{{Σ}_{i} {w}_{i} \cdot {q}_{i}}{{Σ}_{i} {q}_{i}^{2}} ,$$
and
α denotes the scale parameter, wᵢ denotes an element of a subset, qⱼ denotes a quantization point of the subset, L denotes the quantization error, and S_{Q}={αqⱼ}.

11. The method of claim 7, wherein the scale parameter is set differently for each channel or each layer.

12. The method of claim 7, further comprising reperforming the quantization with the approximate weight on the selected pieces of data using the derived scale parameter value.

13. The method of claim 12, further comprising:
determining a quantized approximate weight based on the reperforming of the quantization; and
quantizing a neural network using the quantized approximate weight.

14. A non-transitory computer-readable storage medium storing instructions that, when executed by one or more processors, configure the one or more processors to perform the method of claim 7.

15. An electronic device, the device comprising:
one or more processors configured to:
select some pieces of data from a quantized universal set in a preset operation;
perform quantization with an approximate weight on the selected pieces of data;
determine a quantization error for the quantized pieces of data; and
derive a scale parameter value for minimizing the determined quantization error.

16. The device of claim 15, wherein, for the selecting of the pieces of data in the preset operation, the one or more processors are configured to select the pieces of data, of which a similarity is high with a subset generated based on a Lloyd-Max quantization technique, from the universal set.

17. The device of claim 15, wherein, for the deriving of the scale parameter value, the one or more processors are configured to:
determine an initial value of the scale parameter;
update the scale parameter based on a change of the quantization error; and
output the scale parameter when the change of the quantization error is less than or equal to a preset reference value.

18. The device of claim 15, wherein
for the deriving of the scale parameter value, the one or more processor are configured to derive the scale parameter value for minimizing the quantization error through an iterative operation based on a following equation:
$$∀ i , α {q}_{i} = {arg min}_{p ∈ {S}_{Q}} \vert p - {w}_{i} \vert \\ ℒ = {\sum }_{i} {( {w}_{i} - α {q}_{i} )}^{2} \\ {α}^{*} = \frac{{Σ}_{i} {w}_{i} \cdot {q}_{i}}{{Σ}_{i} {q}_{i}^{2}} ,$$
and
α denotes the scale parameter, wᵢ denotes an element of a subset, qⱼ denotes a quantization point of the subset, L denotes the quantization error, and S_{Q}={αqⱼ}.

19. The device of claim 15, wherein the scale parameter is set differently for each channel or each layer.

20. The device of claim 15, further comprising a memory storing instructions that, when executed by the one or more processors, configure the one or more processors to perform the selecting of the pieces of data, the performing of the quantization, the determining of the quantization error, and the deriving of the scale parameter value.
